(19) United States
(12) Patent Application Publication
(10) Pub. No.: US 2002/0116491 A1
(43) Pub. Date: Aug. 22, 2002

(54) Method and system for probing a network

(76) Inventors: Eric L. Boyd, Ann Arbor, MI (US); Jon Zeeff, Ann Arbor, MI (US)

Correspondence Address: Douglas A. Mullen, Dickinson Wright PLLC, Suite 800, 1901 L. Street, NW, Washington, DC, 20036, US

(21) Appl. No.: 09/945,086

(22) Filed: Aug. 31, 2001

Related U.S. Application Data
(60) Provisional application No. 60/230,236, filed on Sep. 1, 2000.

(51) Int. Cl. G06F 15/173

(52) U.S. Cl. 709/224

(57) ABSTRACT

A method and system of evaluating the performance of a Web site by measuring site performance through the use of probing computers accessing the site including providing executable probing instructions to a probing computer, the probing instructions causing the computer to measure the time to download a predetermined Web page and report the measurement data to a processing computer. The method is further performed by a using a plurality of distributed client computers and a central server and having the steps of communicating a request for work from a client computer to the central server, selecting a work packet for the client computer wherein the work packet includes a work set identifying a Web site for the client computer to probe, using the client computer to download the identified Web site and record performance measurement data relating to the Web site download, communicating the performance measurement data to the central server, and recording the performance measurement data in a searchable database. The invention is also directed to a system for probing a Web site including a distributed network of client computers and a central server. The client computers have client characteristics including a geography, operating system type, and a connection type. The central server controls the probing performed by the distributed client computers and includes a data structure corresponding to each client characteristic, a processor for selecting a work packet for each client computer, and a communication module for communicating with the distributed network of client computers.

### CROSS-REFERENCE TO RELATED APPLICATION

The present invention is related to and claims the benefit of priority from U.S. Provisional Patent Application Ser. No. 60/230,236, filed Sep. 1, 2000 and entitled “Method And System For Probing A Network”.

### REFERENCE TO A COMPUTER PROGRAM LISTING APPENDIX

The file of this patent includes a Computer Program Listing Appendix submitted on one compact disc, including a duplicate compact disc. The Appendix includes the following files

| File Name | Size (in bytes) | Date of Creation |
|---|---|---|
| fez_probester.cgi.c | 4305 | August 30, 2001 |
| fez_probester.html | 15484 | August 30, 2001 |
| fez_probester_ae.c | 17133 | August 30, 2001 |
| fez_probester_ae.h | 557 | August 30, 2001 |
| fez_probester_common.h | 728 | August 30, 2001 |
| fez_probester_config.c | 4797 | August 30, 2001 |
| fez_probester_config.h | 2002 | August 30, 2001 |
| fez_probester_de.cgi.c | 14270 | August 30, 2001 |
| fez_probester_example.html | 1553 | August 30, 2001 |
| fez_probester_test_ae.c | 2444 | August 30, 2001 |
| fez_probester_time.c | 2369 | August 30, 2001 |
| fez_probester_time.h | 531 | August 30, 2001 |
| handle_signal.c | 724 | August 30, 2001 |
| pbc.c | 17543 | August 30, 2001 |
| pbc_multi.c | 20532 | August 30, 2001 |
| pbc_multi.h | 1761 | August 30, 2001 |
| pbc_util.c | 29385 | August 30, 2001 |
| pbc_util.h | 3621 | August 30, 2001 |
| probester.c | 25766 | August 30, 2001 |
| probester_calculations.c | 3960 | August 30, 2001 |
| probester_calculations.h | 1464 | August 30, 2001 |
| probester_dae.c | 26022 | August 30, 2001 |
| probester_dae.h | 1254 | August 30, 2001 |
| probester_dde.pl | 1818 | August 30, 2001 |
| probester_dde_gen.cgi* | 14475 | August 30, 2001 |
| probester_dde_submit.cgi* | 26139 | August 30, 2001 |
| probester_util.c | 16627 | August 30, 2001 |
| probester_util.h | 3629 | August 30, 2001 |
| probesterdb.c | 10367 | August 30, 2001 |
| probesterdb.h | 2601 | August 30, 2001 |
| string_utilities.c | 1565 | August 30, 2001 |
| string_utilities.h | 449 | August 30, 2001 |
| time_limit.c | 1231 | August 30, 2001 |
| time_limit.h | 892 | August 30, 2001 |

Each of the files in the Computer Program Listing Appendix are referenced in the detailed description of this application in areas that provide a description of the operation and general content of each file. The contents of the compact disc are hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Technical Field

This invention relates to a computer method and system for probing network performance, speed, topology, and reliability and, more particularly, to a method and system that coordinates and employs a distributed network of autonomous, participating computers.

2. Discussion

a) The Internet

The Internet comprises a vast number of computers and computer networks that are interconnected through communication links. The interconnected computers exchange information using various services, such as electronic mail, Gopher, and the World Wide Web (“WWW”). The WWW service allows a server computer system (i.e. a Web server or Web site) to send graphical Web pages of information to a remote client computer system. The remote client computer system can then display the Web pages. Each resource (e.g. computer or Web page) of the WWW is uniquely identifiable by a Uniform Resource Locator (“URL”). To view a specific Web page, a client computer system specifies the URL for that Web page in a request according to a commonly agreed upon protocol (e.g. a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that effects the requesting of Web pages and the displaying of Web pages.

As an aside, a request for a Web page might include one or more associated data sets of name/value pairs. Such name/value pairs might be explicitly included in the URL (e.g. http://www.sampledomain.com/index.html?name1=value1&name2=value2) or embedded in the request (e.g. as is commonly done for POST commands in HTTP requests). Normally associated name/value pairs are included only if the resultant Web page is generated dynamically (e.g. via executables conforming to the Common Gateway Interface (CGI) protocol).

Currently, Web pages are typically defined using HyperText Markup Language (“HTML”), although other mark-up languages are in use as well. HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser renders the Web pages as defined by the HTML document. The HTML document contains various tags that control the displaying of text graphics, controls, and other features. The HTML document may contain other URLs or other Web pages available on that server computer system or other server computer system.

The creator of a Web page generally seeks to make the page design visually attractive to the user as well as effective in presenting and marketing the information on the page. However, the designer must also consider the various technical capabilities of the user's computer system, including the internet connection, application system, and browser capabilities. Accordingly, the designer must strike a balance between presenting a visually attractive and rich content Web page versus a page that can be effectively and efficiently transferred to the client's computer system regardless of the system's capabilities. Striking this balance is particularly difficult due to the wide variety of user capabilities and the difficulty in quantifying the computer capabilities of the site visitors. It is not unusual for user's to become frustrated due to delays in accessing specific complex Web pages.

b) Measuring the Internet

The latency to request, deliver, and render a specific Web page associated with a specific URL depends in large part on the location and connectivity of the client computer system making the request, on the location and connectivity of the server computer system answering the request, on network conditions at the instant the request is made, and on network conditions at the instant the request was answered. Accordingly, various techniques have evolved for measuring the performance, speed, topology, and reliability of a network, of which the Internet as a whole is the largest example.

One way of measuring the performance, speed, topology, and reliability of a network is to have some number of representative client computer systems (known as “probes”) repeatedly perform a network test at some interval over some period of time. The results of the tests for a set of probes are then, by some statistical method (typically averaging of some sort), combined in numerical or graphical form to represent the typical performance, speed, and reliability experienced by a user attempting to view a Web page.

There are companies (e.g. Keynote, AtWatch, etc.) currently offering services and products that measure the performance, speed, and reliability of the Internet by measuring specific URLs using probes. There are also companies (e.g. Akamai, Digital Island, etc.) currently offering services and products that claim to improve the performance, speed, and reliability of specific URLs. One weakness in the current state-of-the-art for probing the performance, speed, topology, and reliability of the Internet is that probes are typically set up on dedicated computers placed at specific locations on the Internet's topology. It is straightforward for a company providing some sort of service or product that accelerates or improves the reliability of the delivery of Web pages to “cheat” first by determining the location of a measuring company's probes and second by customizing their service or product to give particularly good results to that probe based on its fixed location.

Moreover, the cost of deploying a single probe prohibits the widespread deployment of thousands or hundreds of thousands of probes. Thus, another weakness in the current state-of-the-art is that the number of probes used to conduct performance, speed, and reliability measurements is a very tiny fraction of the entire network of computers that compose the Internet. The limited number of probes causes a corresponding limited diversity in environments of the probing computers. More particularly, the set of probes are generally positioned in limited geographic locations and lack diversity with regard to types and versions of internet connections, computers, application systems, and browsers. Accordingly, the measurements obtained from a limited probe base do not accurately represent the diversity of normal use and fail to provide sufficient flexibility to measure one or more specifically targeted parameters (e.g., location, internet connection, computer system, application system, or browser).

Finally, the Internet's topology continuously evolves, and a static deployment of probes, no matter how representative at the moment of deployment, cannot continuously evolve in accord with the evolution of the Internet's topology. Thus, another weakness in the current state-of-the-art for probing the performance, speed, topology, and reliability of the Internet is that the characteristics embodied by a set of fixed probes cannot adaptively evolve in accordance with real time changes in the make-up of the Internet as a whole.

c) Using the Internet as a Distributed Processor

The unique capabilities of the Internet have enabled on a global scale a technique for solving a computationally intensive problem whereby the problem is split into multiple sub-problems that can be solved in parallel. The only constraint on theoretically infinite speed-up is the communication and coordination required to divide and allocate the problem and to reassemble and merge the solution. Members of a sub-class of computationally intensive problems are considered “embarrassingly parallel” in that they require almost no communication and coordination relative to the amount of computation required.

As the Internet consists of countless loosely coupled computers, it can be viewed as an ever-growing distributed processor of unthinkable size. As such, any large subset of the Internet is well suited to solve embarrassingly large problems far beyond the ken of the most powerful computers in existence today. The first widely known application to successfully exploit the potential of the Internet's vast computing power was the SETI@home project. SETI, which stands for the Search for ExtraTerrestrial Intelligence, is attempting to scan the stars for signs of life on other planets. Vast amounts of data have been collected, but the analysis of such is computationally intensive. Fortunately, the required analysis meets the definition of embarrassingly parallel, and, as such, is well suited to exploit the distributed processing power of the Internet.

The SETI@home project created a computer program that runs on most commonly available computer systems. Volunteers can download the program and run it on their computer systems at night and at other times when the computer is not doing anything. Periodically, the program checks in to report its latest results and to request additional work from the project's central servers. The central servers coordinate the distribution of work, validate reported results, and aggregate the data. Although no evidence of alien life has been found to date, the combined effort has made great strides towards analyzing all of the collected data.

d) Using the Internet as a Distributed Communication Medium

Many problems require little computation to solve, but are instead dominated by communication and coordination costs. Typical of such problems are solutions that rely on a central coordinator to administer the communication between processors. If the coordination between processors dominates the total amount of communication required, then the central coordinator is likely to become a significant bottleneck that impedes the overall scalability of the solution. On the other hand, if coordination accounts for only a small fraction of the total required communication, then large communication-intensive problems become limited only by the aggregate bandwidth of the communication topology.

The Internet is one of the largest communication mediums ever constructed, rivaled only by the postal system and the telephone system. One of its most important characteristics is the relatively high degree of connectivity between any two points within the network. As such, the Internet is well suited to solve communication-intensive problems that require little centralized coordination.

For example, the popular (if now defunct) tool Napster functioned by “introducing” participants with something to offer to participants making a request. Once the introduction is made, the actual work of transferring the data between two participants requires no coordination whatsoever by the Napster server which made the initial introduction.

Notwithstanding the processing and communication capabilities of the internet, the prior art has failed to recognize the deficiencies of network probing technology based upon a limited number of probes. Conventional probing techniques have also failed to capitalize on the communication capabilities of the internet to provide meaningful site performance data that is representative of the performance, speed, and reliability of the information transfer in relation to the topology and capabilities of the probing computers.

### SUMMARY OF THE INVENTION

In view of the above, the present invention provides a method for probing the performance, speed, topology, and reliability of a network or site on the network from an ever-growing number of voluntarily participating client computers that compose a subset of the Internet. In general, one embodiment of the invention includes a method, and a system performing the method, for a central server in communication with a distributed network of probing computers. The central server acquires environmental and marketing data from each of the client computers, sends test instructions to selected client computers based upon the environmental or marketing data for each computer, receives test data after performance of the test by the client computers, analyzes the received data to determine the performance of the probed location, and reports the performance information to the customer. The reported information is representative of the performance of the probed location over a period of time, from various locations, and can be specifically tailored to model different types of internet connections, computers, application systems, and browsers.

By this method and the associated system, the tests and resulting data may be specifically tailored to satisfy customer needs. For example, if a customer is interested in a specific geographic location, the central server can select probes or specifically tailor test instructions to generate geographic specific data. The server can similarly tailor the probe instructions, e.g., the packet of work dispatched to each computer, to provide performance data relative to specific types of internet connections, computers, application systems, and browsers. This type of information may be particularly valuable to the customer when the customer believes that users having certain technical environments are particularly valuable. Further, the server can initiate tests biased towards determining whether a site performs efficiently and reliably in connection with computer environments having certain characteristics. Based on the results, the customer can adjust the functions of the site accordingly, such as to decrease the complexity of the Web site or limit the number and size of embedded objects. The flexibility of the central server permits the server to generate and distribute test lists to the client computers based upon the above discussed customer needs or to limit the use of certain client computers due to a variety of factors including geographic location, reliability of the computer to generate valuable data, the completeness of the environmental or marketing data that the server has received from the client computer, etc.

In general, each participating client computer receives (whether by downloading from the Internet or some other method) a copy of the probing software. The probing software might be a “permanent” piece of software installed and periodically updated on the client computer, source code that is downloaded and compiled or interpreted on the fly, or some other form of encoded algorithm. While the description provided in this application describes two such mechanism for delivering and initiating the operation of the probing software, other generally apparent mechanisms, or modifications of the described mechanisms, may also be used while achieving the practical applications and benefits of the present invention.

For example, in one embodiment, the probing software is provided to client computers within the distributed network of voluntarily participating computers in response to formatted requests by each client computer. Each participating client computer runs the probing software according to a customizable priority level. One such configuration is to prioritize the probing software to run on the client computer as a low priority process during periods of inactivity on the computer and on the network connection. For example, it may be wrapped in a “screen saver” utility. Another such configuration is to embed the code in the HTML of the probed site as part of an interpreted scripting language (e.g. Javascript) so that the probing software runs only if the page to be measured is visited. For example, the browser might measure the amount of time it takes to download the probed Web site's initial (home) page by interpreting and executing a Javascript code fragment in the HTML code before commencing the downloading of the non-measurement parts of the page and interpreting and executing another Javascript code fragment after it ceases.

In both instances, the probing software is configured to include instructions to measure the amount of time that the client computer takes to download a predetermined Web page. The software may also record relevant marketing data, including, but not limited to, information regarding the client's geographic location, type and speed of Internet connection, type and version of computer, type and version of operating system, and type and version of browser. Alternatively, with the authorization of the user, the server and software can be configured to periodically scan the client computer and/or the active network connection to acquire the marketing environmental data. Thirdly, with the implicit authorization of the user, the server and software can be configured to report publicly available information from the client computer and/or the active network connection without prompting the user for specific authorization.

In operation, the first embodiment of the invention includes probing software that is loaded on the client computer causing it to periodically contact the central server computer to communicate the marketing data and request a packet of work to complete. That packet of work may include, but is not limited to, a list of performance measurements to execute, possibly grouped into related sets (usually pairs), and instructions as to when those measurements should be performed.

After the packet of work is received, the participating client computer performs the specified tests at the specified times. The probing software is configured to measure and record data related to the test. This data can include the amount of time it takes for the client computer to perform the test, such as the time to request and receive a single object or group of objects (typically a single HTML file and a group of embedded objects composing a page), whether or not the request was satisfied, and any other information related to the reasons for success or failure of the measurement. Once some or all of the packet of work is completed, the participating client computer delivers the results of its measurement activities back to a central server computer.

On the server side, the central server computer or network of central server computers receive performance measurement results from the client computers, store the performance results as a record of performed tests, update Metadata tables corresponding to the client characteristics, dispatch work packets to the client computers based upon selection criteria related to the client characteristics and the last time a performance measurement for each work set was dispatched, and provide a Web-based user interface for analyzing performance data . These servers preferably can handle the fact that some fraction of the participating client computers will not complete their packets of assigned work. To compensate, the central server(s) dispatch duplicate work to multiple clients using heuristics that also account for the likelihood of any particular client computer completing the packet of work and for the likelihood of a specific client computer to complete the work.

Moreover, the central server(s) work to ensure that a reasonable number of client computers (not too big and not too small) perform each measurement, that the client computers share certain characteristics (e.g. all lie within the United States), and that the client computers do not share other characteristics (e.g. all run the Microsoft Windows 2000 operating system).

In the second preferred embodiment, the invention uses the Web server to perform the probing instruction dispatch function performed by the central server in the first embodiment. In operation, the client probing software is constructed from an interpreted scripting language, e.g. Javascript. This interpreted probing script is inserted at the beginning of an HTML file (either dynamically if the HTML is constructed on-the-fly or statically if the HTML is constructed a priori) to be measured. When a visitor enters the URL corresponding to that page into a browser, the browser begins to fetch the HTML, including the interpreted probing script via an HTTP request to the Web server. As most commonly used browsers begin interpreting Javascript as soon as it is received, the probing software is initiated before the bulk of the downloading of the web page begins.

The probing software includes multiple bits of script to effectuate the desired measurement. For example, if the time to download and render the Web page is being measured, the first bit of interpreted probing script includes a function that effectively starts a stopwatch. The second bit of interpreted probing script includes a function that effectively stops a stopwatch after all of the HTML and embedded objects are downloaded and rendered and calculates the length of time it took to download and render the page. The third bit of interpreted probing script includes a function that explicitly reports back the measured time interval as a set of name/value pairs. The third bit also functions to contact a specially designated URL that collates associated name/value pairs passed to it when invoked. As a further feature of generating the interpreted scripting language dynamically, multiple specially designated URLs may be used thus allowing multiple central servers to collect the data. The third bit of interpreted probing script may be configured to implicitly report available marketing data, e.g. browser type or client IP address, as part the normally conveyed information of an HTTP request. Additional refinements will be apparent to those skilled in the art including tagging the result with a unique identifier corresponding to only that page.

On the server side, the data collection and analysis aspects of the “central server” functionality may be run on the same machine as the Web server. For example, the central server may include a specially designated data gathering URL (e.g. http://www.sample_domain.com/cgi-bin/report.cgi), wherein the invoked executable (e.g. report.cgi) receives one or more name/value pairs. This received data includes the time it took download the requested Web page as well as, possibly, a tag identifying the particular Web page in question and other available marking data. In addition, additional marking data corresponding to the specific request can be extracted from the access log entry generated by the Web server.

Finally, the central server (s) record the incoming information into a searchable database in a manner similar to the first embodiment.

In both embodiments of the present invention, the searchable database is fed into other analysis programs to determine information regarding performance, speed, topology, or reliability for the entire set of data, for specific probes, for specific visiting browsers or sets of visiting browsers, for certain marketing data criteria, or for the specific measurements performed. The method and system of the present invention provides a direct measurement of the actual performance of the Web site in a variety of circumstances that may be tailored to provide information specifically related to identified client computer characteristics or a more general and random measurement of the Web page performance. In either event, the practical applications of the present invention include the above recited benefits relating to accurate measurement of the Web site under varying conditions. The diagnostic benefits of this real world measurement provide the Web site owner with a better understanding of the operation of the Web site and information from which appropriate modifications to the structure and/or content of the site may be made.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 illustrates the coordination between the central server computer(s) and each client computer in Stages 1 through 6 of the first embodiment of the present invention;

FIG. 2 illustrates the coordination between the central server computer(s) and the data analysis and display engines in Stage 7 of the first embodiment of the present invention;

FIG. 3 illustrates a data analysis engine user interface for the first embodiment of the present invention;

FIG. 4 illustrates a data display engine user interface for the first embodiment of the present invention;

FIG. 5 illustrates the coordination between the Web server and the requesting browser and between the Web server and the data analysis and display engines in the second embodiment of the present invention;

FIG. 6 illustrates a data analysis engine user interface for the second embodiment of the present invention;

FIG. 7 illustrates a data display engine user interface for the second embodiment of the present invention; and

FIG. 8 illustrates the functionality and data structures of the central server pertaining to data recordation, data analysis, and work set selection.

### DETAILED DESCRIPTION OF THE PREFERRED EMBODIMENT

In general, the present invention is directed to a system and method for determining the performance of a Web site wherein the system includes a central server computer 10 and a client computer 12. In both embodiments of the invention described herein, the server 10 receives test data from the probing computer 12, analyzes the data to determine the performance characteristics of the probed Web site 14, and generates output that is representative of the performance. This probing technique provides direct measurement of the real world performance of the Web site from a distributed network of probing computers having various technical characteristics. The central server 10 analyzes the data generated by the probing computers 12 to provide diagnostic information that the site owner can use to modify the content or structure of the site.

The two embodiments of the invention differ in part in the manner in which the probing software is delivered to the probing computer. In the first embodiment, the content and delivery of the probing software is controlled by the central server. This permits the server to control the test criteria (e.g., the content of work packets) dispatched to each probing computer in a desired manner. In the second embodiment, the probing instructions are embedded in the HTML of the measured Web site and thereby delivered to each probing computer when the computer makes a request of the Web site. It is anticipated that other delivery mechanisms may be used without departing from the scope of the invention defined by the appended claims.

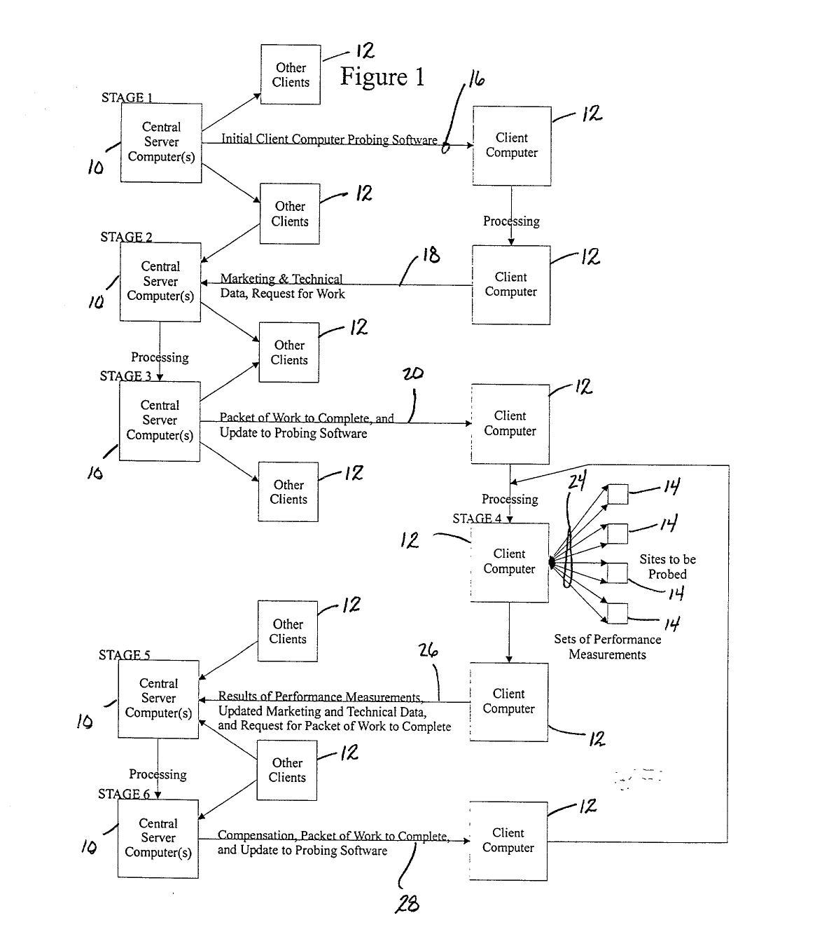

Turning now to the first embodiment illustrated in FIGS. 1, 2, 8, the method is described in seven stages including: (1) loading the probing software on the client computer; (2) the client computer requesting a work packet of performance measurements to execute; (3) the central server sending a work packet to the client computer; (4) the client computer executing the performance measurement and recording the measured results; (5) the client computer delivering the probing results to the central server; (6) an optional step of the central server delivering compensation, such as a record of compensation, and an additional packet of work, if requested, to the client computer; and (7) analyzing the performance measurement data. Those skilled in the art will appreciate from this description and the level of skill in the art that the method may include a fewer or greater number of similar steps to achieve the desired probing efficiency without departing from the scope of the invention defined by the appended claims. For example, in stage 2, the step of the probing computer requesting a packet of performance measurements to perform may also, and preferably does, include registering the probing computer's participation with the central server and providing the central server with marketing and technical data which is stored for use in selecting probing computers from the distributed network of such computers and, optionally, tailoring the content of work packets dispatched to the probing computer. Similarly, in stage 5, the probing computer may provide updated marketing and technical data and request an additional packet of work.

Turning now to a more detailed discussion of the stages of the first embodiment of the invention, FIG. 1 illustrates the coordination between the central server computer(s) and each client computer in Stages 1 through 6. In Stage 1, communication is established between the central server and the client computer to permit the client computer, as shown by communication line 16, to download the probing software needed to participate in the remaining stages. Typical server configuration commands might include the following:

| Field | Example |
|---|---|
| Server Port | 80 |
| Working Directory | /usr/local/probester/ |
| Bind IP Address | 10.10.10.10 |

As shown, the central server(s) is preferably run listening to port 80, the default port for the HTTP protocol. This ensures that communication from clients behind firewalls escapes common anti-virus detection software. However, as the central server(s) may be doing double duty as Web server(s), it is important to be able to bind to a different IP address than that used by the primary Web server. (Representative code for performing these functions and/or operations is found in the probester.c and pbc.c files included in the Computer Program Listing Appendix submitted with this application.)

The probing software includes a pre-compiled executable program that is installed on the client computer and a set of configuration commands. The configuration commands encapsulate configuration options such as the priority at which the probing software is to be run relative to other processes that the user might be using, the frequency and burstiness of requests, how often to check if a network connection is available, etc. Typical client configuration commands might include the following:

| Field | Example |
|---|---|
| Server Name | probester.solidspeed. com |
| Server Port | 80 |
| Client ID | 13842 |
| Connection Type | Enumerated List (e.g. 1 = 28K, |
| | 2 = 56K, 3 = ISDN, 4 = DSL, 5 = |
| | Cable, 6 = T1, 7 = T3, etc.) |
| Max Download Size (bytes) | 61440 |
| Read/Connect Timeout (sec) | 20 |
| Address Resolution Timeout (sec) | 10 |
| Inter-Work Delay Time (sec) | 0 |
| Failed Measurement Retry Flag | False |
| Degree of Debug Logging | 0 |

This list of client configuration commands is designed to minimize the changes in invocation across multiple clients and to ensure that the client does not “run amok” on the client computer in unforeseen circumstances.

Once the probing software is installed, up, and running on the client computer, it scans the technical parameters that describe the client computer's technical configuration, prompts the user to enter marketing data as desired, and confirms that the client computer is allowed to share the technical configuration data. As discussed in greater detail herein, the technical configuration and/or marketing data is part of the data used by the central server to select the work sets for each client computer. (Representative code for performing these functions and/or operations is found in the pbc.c file included in the Computer Program Listing Appendix submitted with this application.)

In Stage 2, as shown by communication line 18, the client computer contacts the central server computer(s) to register its participation as part of the distributed network of such computers, to supply its marketing and technical data (which, in addition to the above discussed technical data, preferably includes the geographic location of the client computer as well as an identification of what version of the configuration commands and the probing software executable are present on the client computer), and to request a packet of work (i.e., performance measurements to perform, including set associations, if any). A typical initial work request might include the following:

| Field | Example |
|---|---|
| Version of Client Software | 2.0.0 |
| Client ID | 13842 |
| Work Time (milliseconds) | 60,000 |
| Client IP Address | 127.45.78.1 |
| Connection Type | One of enumerated List (e.g. |
| | 1 = 28K, 2 = 56K, 3 = ISDN, 4 = DSL, |
| | 5 = Cable, 6 = T1, 7 = T3, etc.) |
| Inventory | Windows 2000, v1.1 |
| Results Flag | 0 |
| Work Request Flag | 1 |

In general, the central server 10 first categorizes the client computer making the request in a database according to the marketing and technical information supplied. The central server then determines the current time. Third, the central server consults the appropriate Metadata tables to determine which of the work sets will most benefit at this time from being served by this particular client computer. This step is optionally repeated until sufficient work sets have been selected at which time the work sets are communicated as a packet of work to the client computer as indicated by communication line 20. (Representative code for performing these functions and/or operations is found in the probester.c and pbc.c files included in the Computer Program Listing Appendix submitted with this application.)

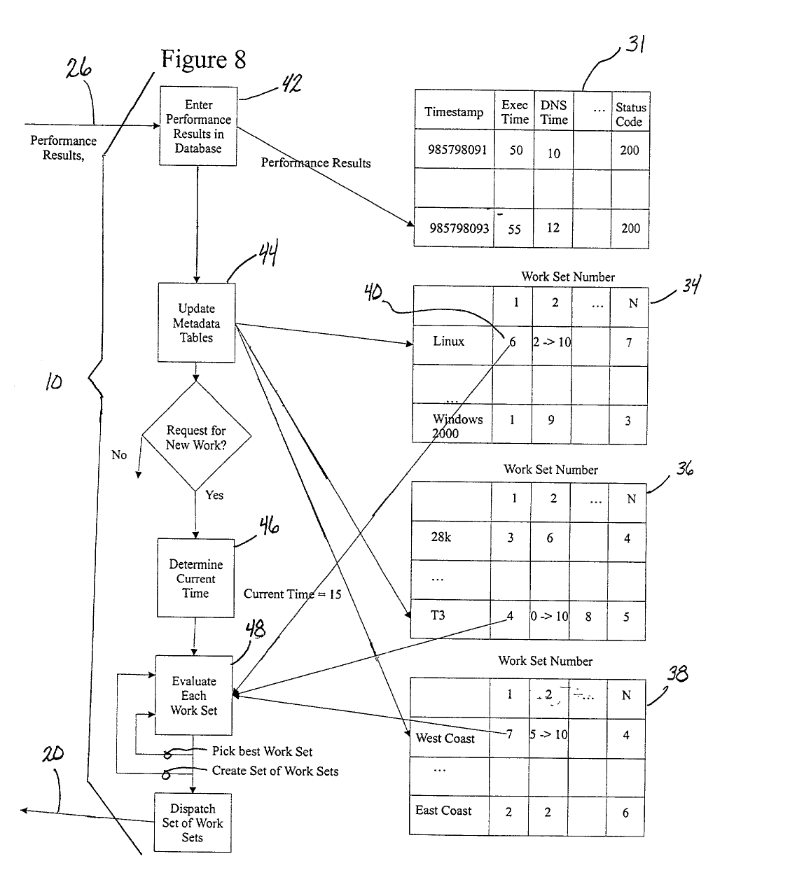

More particularly, in the last (repeated) step, it is first necessary to understand what Metadata is stored and how it is evaluated. Metadata regarding the volume of acquired data is stored in a table format where each table corresponds to a different data type (e.g browser type, connection type, operating system type, etc.). Representative Metadata tables illustrated in FIG. 8 include an operating system data structure 34, a connection type data structure 36, and a geography data structure 38. Within each data structure or table, each column corresponds to a work set representing a set of URLs to be probed and each row corresponds to a different legal value for that particular data type. For example, in the operating system data structure 34 illustrated in FIG. 8, each row corresponds to a different operating system type, e.g., Linux, Windows 2000, etc. Similarly, for the connection type table 36, each row corresponds to a different legal connection type, e.g. 28K, 56K, ISDN, DSL, Cable, T1, T3, etc. and for the geography table 38, each row corresponds to a different geographic location or region, e.g. West Coast, East Coast, etc.. The value within each cell (of which 40 is an example) of the Metadata tables corresponds to the time that a work packet was dispatched to a client computer having the identified characteristics and for the identified work set number. In the case of cell 40, the operating system is Linux and the Work Set Number is 1.

Every time performance data is submitted to the central server(s), as discussed below in Stage 5, performance results are stored in table 31 and the appropriate cell in each Metadata table is updated. For example, as is also illustrated in FIG. 8, performance results received from a client's computer along communication line 26 are entered into the performance data structure 31 at step 42. At step 44, each Metadata table is updated with the reported dispatch time in the cell corresponding to the appropriate client characteristic and work set number. The client characteristics, dispatch time, and work set number for this example consist of:

```
Dispatch Time = 10
Work Set No. = 2
Client Characteristics
    Operating System = Linux
    Connection Type = T3
    Geography = West Coast
```

Thus, the cell corresponding to the row labeled Linux and the column for Work Set 2 is updated on table 34 from 2 to the latest dispatch time, 10. Likewise, the cell corresponding to the row labeled T3 and the column for Work Set 2 is updated on table 36 from 0 to the latest dispatch time, 10, and the cell corresponding to the row labeled West Coast and the column for Work Set 2 is updated on table 38 from 5 to the latest dispatch time, 10.

As further illustrated in FIG. 8, if the performance results include an additional request for work, the central server determines appropriate work sets to send in the next packet of work (steps 46 and 48). To determine a work set, the central server determines the current time at step 46, in this example equal to 15. It then looks at one cell from each Metadata table for a given Work Set where the selected row corresponds to the value of that particular client for that particular characteristic. For example, for the illustrated reporting client computer having client characteristics of a Linux operating system, T3 connection type, and West Coast geography, the central server looks at Work Set 1 and the Linux row in the operating system table 34 and retrieves the dispatch time entry “6”. The central server includes a processor that then calculates the difference between the current time and the dispatch time for that cell, in this case “15−6=9”. The central server repeats this calculation for the cell in table 36 and the cell in table 38 corresponding to Work Set 1 and connection type T3 or geography West Coast, respectively. Then, the central server calculates the product of the differences corresponding to Work Set 1 from each Metadata table. In this case, that is the product of (15−6) from table 34, (15−4) from table 36, and (15−7) from table 38. This entire process is then repeated again for each Work Set. The work set with the largest product wins and is added to the list of selected work sets. Ties are resolved randomly. In the illustrated example, the products for work set numbers 1, 2, and N are as follows:

Work Set No. 1: (15−6)*(15−4)*(15−7)=792

Work Set No. 2: (15−10)*(15−10)*(15−10)=195

Work Set No. N: (15−7)*(15−5)*(15−4)=880

Thus, work set N is selected. If one work set is not defined as sufficient work for a client, then the entire process is repeated again to select additional work sets, as needed. In this case, the second selected work set (assuming the client could handle two work sets) would be work set 1. The set of selected work sets is then dispatched to the client computer as indicated by line 20.

This heuristic can be refined to account for customers with varying interests. Rather than simply taking the product of the differences corresponding to that work set from each Metadata table, the product is calculated from differences taken only from Metadata tables of interest to the customer corresponding to the particular work set. This can be specified in another table (not shown), where each column corresponds to a work set and each row corresponds to a different characteristic (e.g. browser type, connection type, operating system type, etc.). Each cell within this Metadata table has a value of 0 or 1. Only if the value is one is the difference multiplied into the product defined above.

In Stage 3, and as illustrated by communication line 20 in FIG. 1, the central server computer communicates the packet of work to be performed to the client computer. In addition, the central server provides updates, such as a new version of the executable and/or the configuration commands, to the client computer's probing software, if any are required. The probing software on the client computer then schedules the performance measurements. A typical packet of work might include the following:

| Field | Example |
|---|---|
| Server Time | 985798091 |
| Time Limit (seconds) | 60 |
| Time Tolerance (seconds) | 10 |
| URL #1 | |

| | |
|---|---|
| URL ID | 175 |
| URL | http://www.aaa.com/foo.html |
| Host Header | www.aaa.com |
| Cache Flag | 0 |
| Embedded Content Flag | 1 |

. . .
URL #N

| | |
|---|---|
| URL | http://www.zzz.com/bar.html |
| Host Header | www.zzz.com |
| Cache Flag | 0 |
| Embedded Content Flag | 1 |

For each work set that can be completed within the allotted time limit plus or minus the time tolerance, the client performs the actual performance measurement. Generally, this process corresponds to starting a stopwatch, downloading the Web page content, and stopping a stopwatch, where downloading the Web page content corresponds to the behavior of a typical browser without the display and rendering functionality. First, the client starts a stopwatch. Then the client constructs the URL to be fetched. This HTTP request is composed from the URL, the host header, and the cache flag in accordance with the HTTP protocol. The cache flag dictates whether or not to set “no cache” headers on the HTTP request depending on whether or not one wants to measure the impact of caching or not. Then the client does a DNS name lookup of the domain contained within the UR1. Then the client opens a socket to the IP address corresponding to that domain name and port 80. Then the client issues an HTTP request for the object. Then the client reads the HTTP response packet, if any returns. Then, if the “embedded content flag” is set, the client repeats the process for each embedded object. If the request takes too long, the client times out and sets the appropriate status code. Last, the client stops the stopwatch. (Representative code for performing these functions and/or operations is found in the probester.c and pbc.c files included in the Computer Program Listing Appendix submitted with this application.)

In Stage 4, the client computer executes each performance measurement at the appropriate time by requesting the URL and embedded object identified in the work set and probing the designated Web sites 14 such as illustrated by communication lines 24 (FIG. 1). The probing software causes the client computer to record the results of the Web site download, generally the duration of time that it takes for the client computer to download the content of the site thereby providing a direct measurement of the performance, speed, and reliability of the site. While this description represents a single communication event for reporting the results for a set of performance measurements, it is contemplated that the results may be communicated in a series of events following the completion of a specific performance measurement. During some or all executions of this stage, the client computer preferably updates its marketing data and/or technical data. (Representative code for performing these functions and/or operations is found in the handle_signal.c, pbc.c, pbc_multi.c, pbc multi.h, bpc_util.c, and pbc_util.h files included in the Computer Program Listing Appendix submitted with this application.)

In Stage 5, the client computer delivers, such as through communication link 26, the results of the performance measurements performed, provides updated marketing and technical data, and requests another packet of work to complete (or indicates its unwillingness to participate further). A typical subsequent work request might include the following:

| Field | Example |
|---|---|
| Version of Client Software | 2.0.0 |
| Client ID | 13842 |
| Work Time (milliseconds) | 60,000 |
| Client IP Address | 127.45.78.1 |
| Connection Type | One of enumerated List (e.g. |
| | 1 = 28K, 2 = 56K, 3 = ISDN, 4 = DSL, |
| | 5 = Cable, 6 = T1, 7 = T3, etc.) |
| Inventory | Windows 2000, v1.1 |
| Results Flag | 1 |
| URL #1 | |
| URL ID | 175 |
| Execution Time (ms) | 50 |
| DNS Name Resolution (ms) | 10 |
| Connection Time | 1 |
| Redirect Time | 0 |
| Byte 1 Time | 2 |
| Page Time | 107 |
| Content Time | 203 |
| Bytes Read | 10783 |
| HTTP Response Status Code | 200 |
| . . . | |
| URL #N | |
| URL ID | 176 |
| Execution Time (ms) | 55 |
| DNS Name Resolution (ms) | 12 |
| Connection Time | 0 |
| Redirect Time | 0 |
| Byte 1 Time | 3 |
| Page Time | 154 |
| Content Time | 298 |
| Bytes Read | 12486 |
| HTTP Response Status Code | 200 |
| Work Request Flag | 1 |

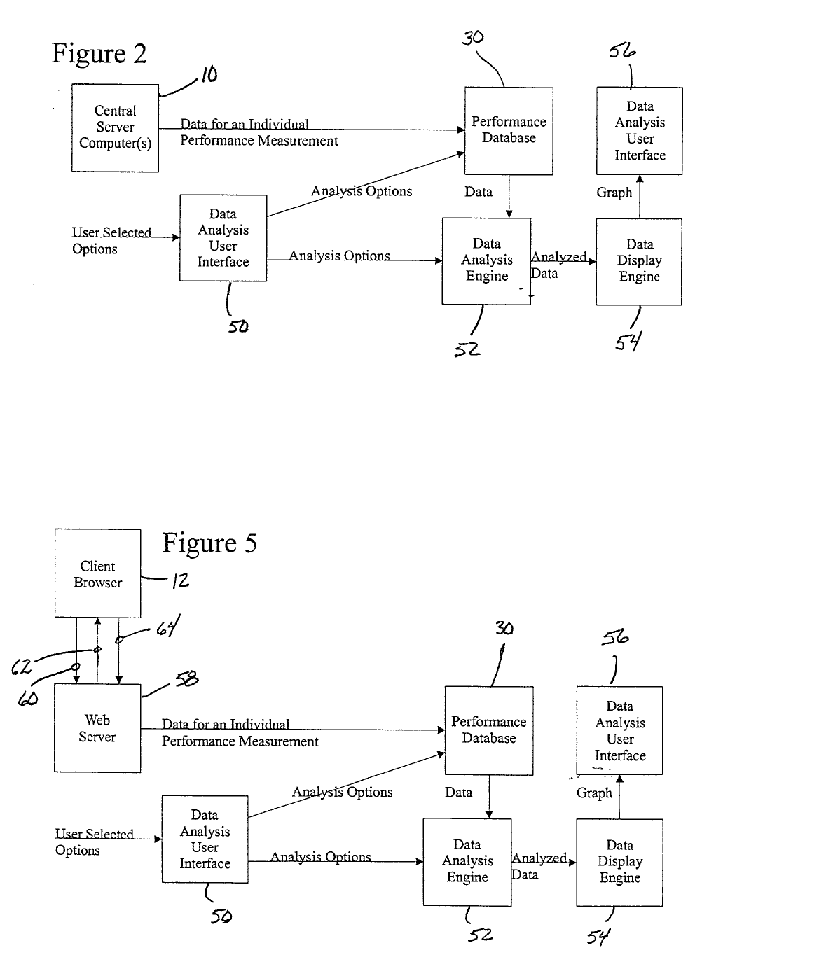

The central server then records the performance measurement data for both real-time and post-processing analysis in a searchable database 30 (FIG. 2). For each name/value pair reported by the client computers and stored by the table of performance data, the “name” is used to identify the appropriate column and the “value” is written into the row corresponding to the current set of data. If there is any additional data to be gleaned from the associated access log line, that data is collected in the form of name/value pairs and stored in the database as well. The resultant table of data might include some or all of the following column headers (and associated values for each measurement):

| Field | Definition |
|---|---|
| Client ID | Unique client identifier. |
| Client IP Address | IP address of client (implicitly |
| | identifies geography). |
| Client Connection Type | Enumerated list of types |
| | e.g. 28K, 56K, ISDN, DSL, |
| | Cable, T1, T3, etc. |
| Inventory | Operating system and version of |
| | client. |
| URL ID | Unique URL identifier. |
| Execution Time | Timestamp that particular URL was |
| | executed according to server |
| | clock. |
| DNS Time | Time to do DNS name resolution of |
| | initial page. |
| Connection Time | Time spent in connect () call. |
| Redirect Time | Time from initial HTTP redirect |
| | to final connect. |
| Byte 1 Time | Time from final connect to first |
| | byte downloaded. |
| Page Time | Time to download remainder of |
| | object. |
| Content Time | Time to download embedded |
| | content (frame source, images, |
| | etc.) |
| Server Time | Time in milliseconds that work |
| | was being done on client |
| # of Bytes | Number of bytes downloaded (not |
| | including header. |
| HTTP Status Code | Result code of HTTP request. |

The central server also determines the intrinsic value of the performance measurement based on the number of filled-out fields in the database record for this particular client and on the perceived value of each filled-out field. Numerous compensation structures and corresponding equations may be used with the present invention to provide this function. Finally, the central server computer calculates the appropriate compensation for the work and (if more work is requested) determines a new packet of work (consisting of one or more sets of performance measurements to perform) appropriate to the revised characteristics of the participating client computer.

In Stage 6, the central server computer delivers, such as via communication link 28, a new packet of work (if requested) along with compensation or a record of the compensation earned for the last transaction. In addition, the central server provides updates to the client computer's probing software (either a new version of the executable and/or the configuration commands), if any are required (and if more work is requested). The probing software on the client computer then schedules the performance measurements as described in Stage 3. A typical work response would be the same as shown for Stage 3.

The process then continues by returning to Stage 4 or terminates if no more work is requested. (Representative code for performing the central server(s) functions and/or operations in Stages 1-6 is found in the probester.c, probester_util.c, probester_util.h, string_utilities.c, string_utilities.h, time_limit.c, time_limit.h files included in the Computer Program Listing Appendix submitted with this application. The last six files include support functionality for the main server code found in probester.c)

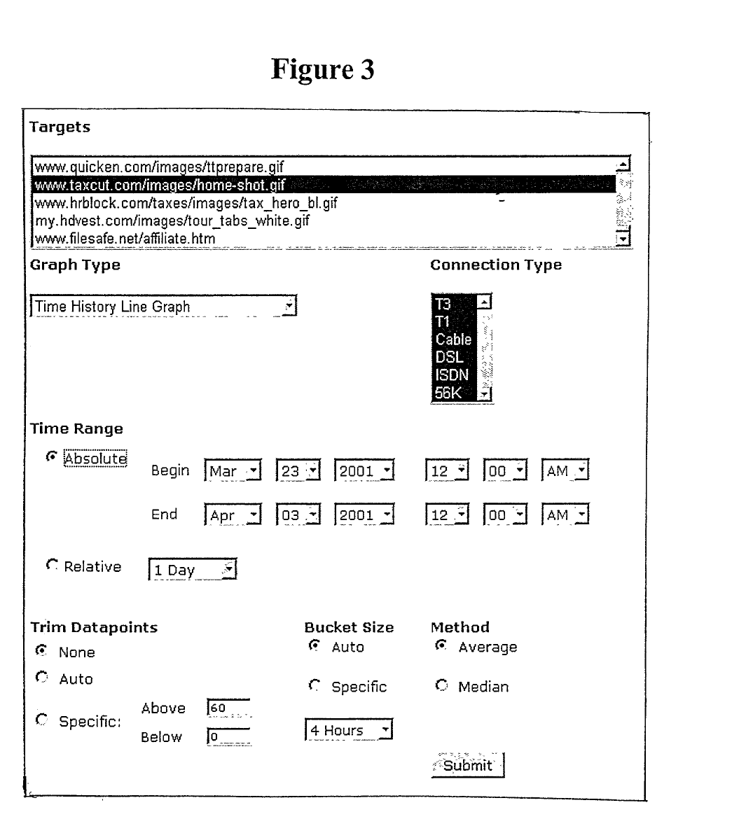

As a result of the above described process, and corresponding structure of the central server, the central server database(s) are populated with performance measurements of the probed sites as well as, preferably, marketing and technical data relating to each of the client computer's performing the site measurements. The central server computer 10 is configured to analyze the stored data to provide specific measurement information related to the performance of the probed sites. This analysis, performed in Stage 7 illustrated in FIG. 2, happens independently of Stages 1-6 and is initiated when the owner or administrator of the measured Web site decides to analyze the results of the performance measurement. While a variety of mechanisms, such as user interfaces and the like, may be used to prompt the Web site administrator to begin analysis, the Web site administrator initiates analysis in the preferred embodiment by selecting the desired analysis options via a Web page interface, data analysis user interface 50 (FIG. 2) such as that illustrated in FIG. 3. (Representative code for performing these functions and/or operations is found in the probester_dde_gen.cgi and probester_dde.pl files included in the Computer Program Listing Appendix submitted with this application.) Such options might typically include:

| Field | Example |
|---|---|
| UR1 #1 | http://www.abc.com/foo.html |
| . . . | |
| UR1 #N | http://www.xyz.com/bar.html |
| Graph Type | One of enumerated list (e.g. |
| | Time History Line Graph, |
| | Component by Time Bar Graph |
| | Component by Connection Bar Graph, |
| | Component by Connection Pie Graph, |
| | Error by Time Histogram |
| | Error by Connection Histogram |
| Connection Type | One of enumerated list (e.g. |
| | T3, T1, Cable, DSL, ISDN, 56K, 28K) |
| Time Range | Absolute/Relative |
| Absolute Start Time | Month/Day/Year/Hour/Minute/AM or PM |
| Absolute End Time | Month/Day/Year/Hour/Minute/AM or PM |
| Relative Time Period | 1 Day, 2 Days, 3 Days, 1 week, 2 |
| | weeks, 3 weeks, 1 month |
| Trim Data Points | None/Auto/Specific |
| Specific Trim Above (secs) | 60 |
| Specific Trim Below (secs) | 0 |
| Bucket Size | Auto/Specific |
| Bucket Specific Size | 1 hour/2 hours/3 hours/4 hours/6 |
| | hours/12 hours/1 day/1 week |
| Method | Average/Median |

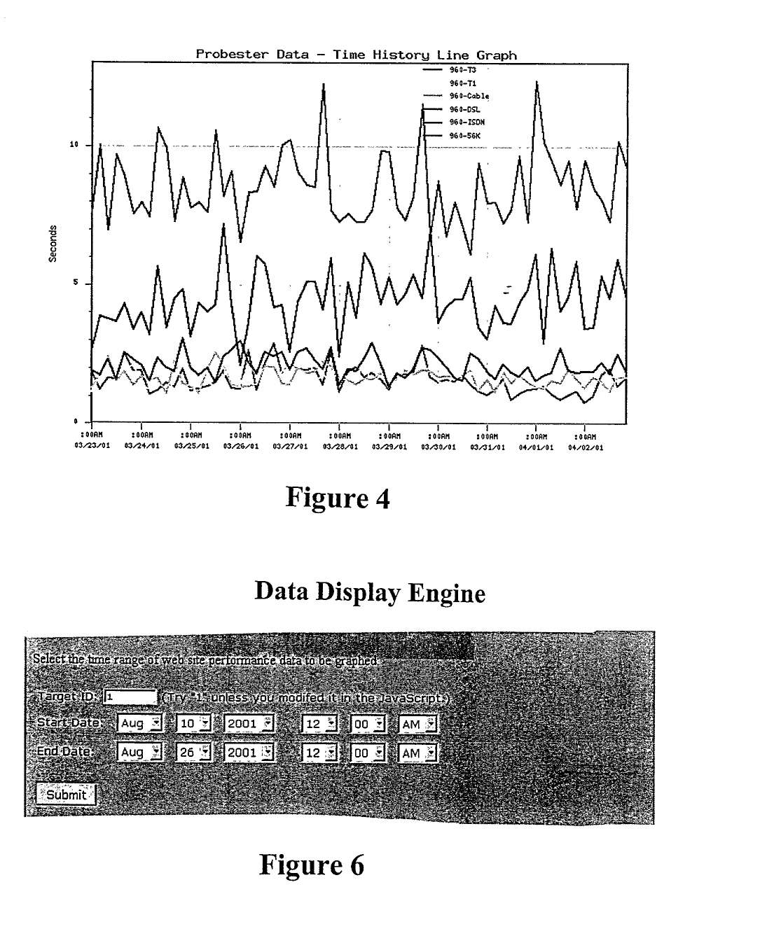

Once the options are selected, they are passed in to a data analysis engine 52 of the central server (FIG. 2). The data analysis engine parses the raw data and derives the analyzed data. (Representative code for performing these functions and/or operations is found in the probester_calculations.c, probester_calculations.h, probesterdb.c, probesterdb.h, probester_dae.c and probester_dae.h files included in the Computer Program Listing Appendix submitted with this application. The files probesterdb.c and probesterdb.h provide the interface to the performance results table. The files probester_calculations.c and probester_calculations.h do the actual analysis. The files probester_dae.c and probester_dae.h coordinates the overall process.) The data analysis engine then passes the analyzed data to a data display engine 54 which generates a display, such as a graph. (Representative code for performing these functions and/or operations is found in the probester_dde.pl and probester_dde_submit.cgi files included in the Computer Program Listing Appendix submitted with this application.) The display is communicated to a data analysis user interface 56 which displays the result via some a user interface, typically another Web page such as in the manner shown in FIG. 4. Those skilled in the art will appreciate that a variety of data analysis and display techniques may be used with the present invention to provide meaningful diagnostic information regarding the performance of the Web site thereby permitting the site administrator to make any necessary or desired modifications to the site.

One benefit of this embodiment of the invention is that it enables the creation of a network of probes on a scale that is not commercially viable for an approach employing dedicated computers placed at specific locations on the Internet's topology as probes. This benefit is realized in at least two ways: it allows the purchase of a “marginal probe” and it allows the purchase of a performance measurement at deeply discounted rates. The cost of a single performance measurement includes both fixed costs, such as the cost of the client computer hardware, rack, maintenance, insurance, and taxes, and variable costs, such as the cost of the bandwidth required to complete a performance measurement. By transforming existing client computers, for which the fixed costs are paid by their owners, into “marginal probes,” this invention reduces the maximum cost of a performance measurement to its variable cost. Moreover, many potential client computers pay a fixed cost for bandwidth (e.g. unlimited local phone calls for a fixed price from the local phone company and unlimited Web access for a fixed price from the local Internet Service Provider (ISP)), but do not use that access continuously, in effect wasting some of the potential bandwidth they are paying for. This invention enables the owner of a participating client computer to effectively resell some of that wasted bandwidth and provides and incentive to do so, even if the amount they recoup is less than the amount it costs them. For example, if the owner of the client computer is wasting $10 a month in bandwidth, it is to his advantage to sell that wasted bandwidth at $5 a month if that is the highest price he can find, simply to minimize the amount of money he is wasting.

A second benefit of this embodiment of the invention is the ability to segregate performance measurement data according to marketing and technical characteristics. By associating the technical and marketing data of a particular client computer with the result of a set of performance measurements, the present invention associates the performance, speed, and reliability experienced by a user with the marketing or technical characterization of the user. For example, one can determine the typical experience of users having common characteristics, such as according to whether they have a 56K dial-up connection, a cable modem, or a DSL connection. As another example, one can determine the typical experience of users who have made an online purchase within the past thirty days.

A third benefit of this embodiment of the invention is that it improves the value of the performance measurement data gathered in at least two ways: the data more accurately reflects the true user experience and the data is less likely to be biased in favor of better financed services promising improvements in performance, speed, topology, and reliability. Both benefits are derived from the increased number of participating computers facilitated by this invention. As the number of client computers is increased, even if the number of performance measurements per probe is decreased, the net effect is to increase the diversity of the client computers (from both a marketing and technical perspective) and thus increase the degree to which the probe network is representative of the Internet at large. Moreover, as the characteristics of a typical user evolve (e.g. as the number of Internet users employing cable modems increases), the network of probes enabled by this invention evolves in tandem. Finally, by nature of the large number of probes facilitated by this invention, it becomes almost impossible for a performance enhancement service to “cheat” by placing accelerators (e.g. servers that mirror or cache copies of other Web sites) near each and every probe. Moreover, since the central server computers can rapidly and continuously change which subset of probes are performing a specific performance measurement, no fixed placement of accelerators can shadow the placement of probes.

Turning now to a second embodiment of the present invention wherein rather than seeking voluntary client computers and loading the probing software onto such computers, the present invention includes the client probing software in the form of snippets of Javascript as an additional attribute to one tag of the Web site HTML. The differences in the second embodiment relative to the above described first embodiment are most apparent in the first three stages of the method illustrated in the client server interactions shown in FIG. 1. More particularly, the client or probing computers are now those computers that make requests of the Web site in the normal course of internet activity and without prompting by any communication by the central server. Further, there is no registration of the client computers with the central server or communication of marketing and technical data, requests for work or packets of work prior to the client computers communication with the Web site. Notwithstanding these differences, each of the described embodiments of the invention have common characteristics such as providing Web site performance information from client computer contact with a Web site through a distributed client computer network, communicating the results of the performance measurements (and available marketing and technical data pertaining to the client computer making the measurements) for further analysis in the manner provided by the central server computer.

In Stage 1, a computer user wishing to visit a specific Web site types a URL into a browser. The browser then generates an HTTP request for the URL to the corresponding Web server 58 as shown by communication line 60 in FIG. 5. The Web page is then generated on-the-fly or fetched from storage by the Web server and delivered to the requesting browser by way of an HTTP response as shown by line 62. Assuming that the URL corresponds to a Web page measured by means of the second embodiment of the invention, the Web page includes the client probing software in the form of a snippet of Javascript, or other commonly employed interpreted scripting language, and an additional attribute to one tag of the HTML. This interpreted probing script is preferably inserted at the top of an HTML file. As most commonly employed browsers begin executing Javascript as soon as it is received, the Javascript is effectively invoked immediately and runs until the Web page is entirely retrieved. While those skilled in the art will appreciate that other interpreting scripting languages other than Javascript may be used with the present invention, Javascript is preferred due to its compatibility with current browsers. (Representative code for performing these functions and/or operations is found in the fez_probester_example.html files included in the Computer Program Listing Appendix submitted with this application.)

The interpreted probing script preferably includes dedicated bits configured to perform specific measuring functions, such as the hereinafter described function of timing the download of the HTML file by the probing computer. In this functional application, the first bit of interpreted probing script includes a function that effectively starts a stopwatch. With Javascript, this is easily accomplished as follows:

start=new Date();

The second bit of interpreted probing script includes a function that effectively stops a stopwatch after all of the HTML and embedded objects are downloaded and rendered and calculates the length of time it took to download and render the page. With Javascript, this is easily accomplished as follows:

function complete_measurement ()
{

end = new Date ();
var d1=end.getTime () -start.getTime ();

}

assuming that the HTML is modified to include the “onLoad” attribute in the HTML “body” tag as follows:

<BODY onLoad=“complete_measurement()”>

The third bit of interpreted probing script includes a function that reports the measured time interval and, possibly, available marketing data back to the Web site as shown by line 64. With Javascript, this is easily accomplished by embedding the following line in the complete_measurement( ) function as follows:

s=new Image( );

s.src=“http://www.sample_domain.com/cgi-bin?dl_time=”+dl;

As an additional refinement, the reported data may be tagged with a unique identifier corresponding to only that Web page. Putting this all together with Javascript, this is easily accomplished by embedding the following script into the HTML page:

<SCRIPT LANGUAGE=“JavaScript”>
server=“http://www.sample_domain.com/cgi-bin/report.cgi”;
target_no=1;
start = new Date ();
function complete_measurement ()
{

end = new Date ();
var d1=end.getTime () -start.getTime ();
// Uncomment the following line for testing.
// alert (‘This page downloaded in ‘+d1/1000+’ seconds.’);
s=new Image ();
s.src=server+“?target_no=”+target_no+“&”+“d1_time=”+d1;

}
</SCRIPT>

that the HTML is modified to include the “onLoad” attribute in the HTML “body” tag as follows:

<BODY onLoad=“complete_measurement( )”>

As noted, available marketing data (e.g., browser type, client IP address, etc.) is or can be implicitly reported as part of an HTTP request and included as additional name/value pairs passed to the report.cgi executable.

In Stage 2 of this second embodiment, the Javascript probing software has already caused by the probing computer to implicitly communicate the calculated measurement results, e.g., download time, as well as the associated marketing data back to the central server(s) by invoking the URL specified in the “s” variable of the Javascript (e.g. http://www.sample_domain.com/cgi-bin/report.cgi.?target_no=1&d1_time=75) and attaching one or more name/value pairs. The Web server invokes the executable report.cgi, which then takes this data and writes it into a table in a performance database 30, such as a flat file. For each name/value pair, the “name” is used to identify the appropriate column and the “value” is written into the row corresponding to the current set of data. If there is any additional data to be gleaned from the associated access log line, that data is collected in the form of name/value pairs and stored in the database as well. The resultant table of data might look as follows:

| | | | Download_{—} |
|---|---|---|---|
| Time_Stamp | Requestor's_IP_Address | Target_# | Time |
| 985798091 | 10.10.10.10 | 1 | 75 |
| 985798093 | 64.10.3.75 | 1 | 75 |
| 985798093 | 22.128.44.7 | 1 | 75 |
| 985798094 | 64.10.3.75 | 1 | 75 |

(Representative code for performing for performing these functions and/or operations is found in the fez_probester.cgi.c, aka report.cgi files included in the Computer Program Listing Appendix application.)

In Stage 3 of this second embodiment, which happens independently of Stages 1-2, the owner or administrator of the measured Web site decides to analyze the results of the performance measurement. This begins by selecting the desired analysis options via some sort of user interface, typically a Web page, such as the interface shown in FIG. 6. Such options might typically include:

| Field | Example |
|---|---|
| Target ID | 1 |
| Start Time | Month/Day/Year/Hour/Minute/AM or PM |
| End Time | Month/Day/Year/Hour/Minute/AM or PM |

Options listed for Stage 7 of the first embodiment of the preferred invention are possible as well. (Representative code for performing these functions and/or operations is found in the fez_probester.html file included in the Computer Program Listing Appendix submitted with this application.)

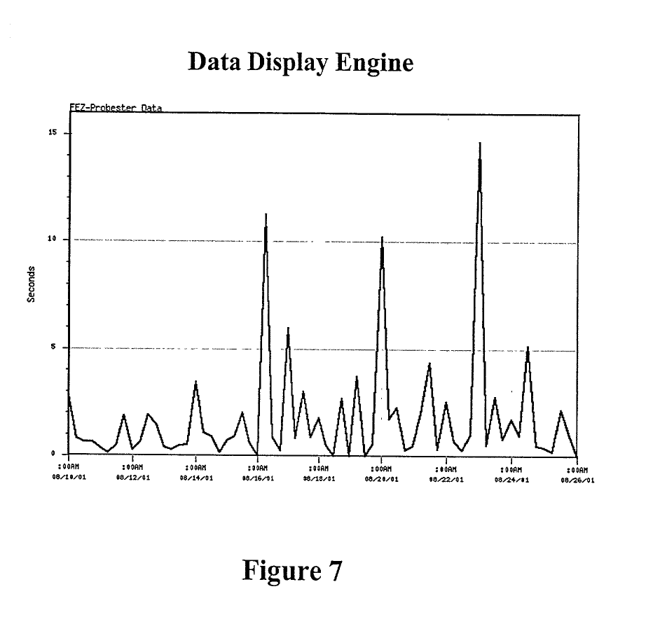

Once the options are selected, they are passed in to a data analysis engine 52 (FIG. 5). The data analysis engine parses the raw data and derives the analyzed data. (Representative code for performing these functions and/or operations is found in the fez_probester_ae.c and fez_probester_ae.h files included in the Computer Program Listing Appendix submitted with this application.) The data analysis engine then passes the analyzed data to a data display engine 54. The data display engine generates a display, such as a graph. The display is communicated to a data analysis user interface 56 which displays the result via a user interface, typically another Web page. (Representative code for performing these functions and/or operations is found in the fez_probester_de.cgi.c file included in the Computer Program Listing Appendix submitted with this application.) Configuration parameters of the data display engine functionality are defined via configuration files. (Representative code for performing these functions and/or operations is found in the fez_probester_common.h, fez_probester_config.c and fez_probester_config.h files included in the Computer Program Listing Appendix submitted with this application.) Support for converting time into different formats is provided as well. (Representative code for performing these functions and/or operations is found in the fez_probester_time.c and fez_probester_time.h files included in the Computer Program Listing Appendix submitted with this application.) An example of the displayed data is illustrated in FIG. 7.

Many of the benefits discussed above with respect to the first embodiment of the present invention is also achieved by this second embodiment. For example, the second embodiment also enables the creation of a network of probes on a scale that is not commercially viable for an approach employing dedicated computers placed at specific locations on the Internet's topology as probes. In the second embodiment this benefit is realized by making performance measurements essentially free, as total increases in load on the server, incoming and outgoing bandwidth, and perceived performance of Web pages are minimal. The load on the server only goes up as far as processing the incoming performance data and writing it into a database. The outgoing bandwidth increases on a per measured page basis downloaded per visitor by the number of bytes needed to represent the interpreted probe software. The incoming bandwidth increases on a per measured page basis downloaded per visitor by the number of incoming bytes needed to record the gathered data. The impact on the perceived performance is equal to the amount of time needed to download the extra interpreted probe software plus the time to interpret and execute that software. In effect, the visitor does the actual performance measurement for free just by visiting the measured page.

Another benefit shared by both embodiments of the invention is the ability to segregate performance measurement data according to marketing and technical characteristics. By associating the technical and marketing data of a particular client computer with the result of a set of performance measurements, both embodiments associate the performance, speed, and reliability experienced by a user with the marketing or technical characterization of the user. In this second embodiment, for example, one can determine the typical experience of users in a particular geographic region by requesting IP addresses to general geographic areas (which is available from companies such as Quova) and then correlating performance with geographic area.

Yet another shared benefit of both embodiments of the invention is that they improve the value of the performance measurement data gathered in at least two ways: the data more accurately reflects the true user experience and the data is less likely to be biased in favor of better financed services promising improvements in performance, speed, topology, and reliability. In this second embodiment, both benefits are derived from the fact that the set of performance measurements taken exactly represents the performance experience by actual end users during their actual browsing session.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A method of evaluating the performance of a web site by measuring site performance through the use of probing computers accessing the site, said method comprising:
providing executable probing instructions to a probing computer, said probing instructions causing the computer to measure the time to download a specified Web page and report the measurement data to a processing computer.

2. The method of claim 1 wherein the step of providing the probing instructions to the probing computer includes embedding the probing software in the HTML of the Web page.

3. The method of claim 2 wherein the probing software is an additional attribute to one tag of the specified Web page HTML.

4. The method of claim 2 wherein the probing instructions include a first bit of interpretive probing script that starts a timer, a second bit of interpreting probing script that stops the timer after all of the Web site HTML and embedded objects are downloaded by the probing computer and calculates the length of time to download the page, and a third bit of interpreted probing script that causes the client computer to report the measured time interval to a processing computer.

5. The method of claim 4 wherein the third bit of interpreted probing script is further configured to report available client characteristics of the probing client computer to the processing computer.

6. The method of claim 1 wherein the reported data is tagged with an identifier for the specified Web page.

7. The method of claim 1 wherein the step of providing the probing instructions to the probing computer includes communicating probing software from a central server to the client computer.

8. The method of claim 1 further including the steps of analyzing the measurement data and communicating display data to a display engine for user display in graphical form.

9. A method of probing a Web site to produce measurement data representative of the web site performance using a plurality of distributed client computers and a central server, comprising:
communicating a request for work from a client computer to the central server;
selecting a work packet for the client computer, said work packet including a work set identifying a Web site for the client computer to probe;
using the client computer to download the identified Web site and record performance measurement data relating to the Web site download;
communicating the performance measurement data to the central server; and
recording the performance measurement data in a searchable database.

10. The method of claim 9 further including the step of the client computer reporting client computer characteristics to the central server, said client computer characteristics including one or more of the geographic locations of the client computer, an identification of the configuration commands, an identification of the probing software, the operating system of the client computer, and the connection type of the client computer.

11. The method of claim 10 wherein the central server includes a data structure corresponding to each client characteristics, a processor for selecting a work packet for each client computer, and a communication module for communicating with the plurality of distributed client computers including to receive performance measurement data from the client computers and to send work packets to the client computers, each of said data structures including a work set identifier corresponding to each of the plurality of work sets, a listing of each client characteristic, and a time entry representing the last time that each work set was probed by a client computer having each client characteristic, and wherein the method further includes the steps of determining the characteristics of the client computer communicating the request for work and wherein the step of selecting the work packet for the client computer includes identifying each of the plurality of work sets having the client characteristics of the client computer requesting work, determining the time entry in each data table field corresponding to each of the identified work sets and the characteristic of the client computer requesting work, determining the current time, subtracting each time entry from the current time, calculating the product of differences, and selecting the work set having the largest product.

12. The method of claim 11 further including repeating the step of selecting one of the identified work sets if the client computer requests a work package having more than one work set.

13. The method of claim 9 further including the step of the central server storing the performance measurement data received from the client computers in a performance database.

14. The method of claim 13 wherein said central server further includes a data analysis user interface, a data display engine, a data analysis engine communicating with the performance database and the data display engine, and a data analysis user interface communicating with said data and analysis engine for receiving a data display and displaying the data display to a user, and further including the steps of selecting analysis options using the data analysis user interface, generating a data display through the data display engine, and displaying the data display to the user through the data analysis user interface.

15. The method of claim 9 further including the step of communicating probing software to the client computer, the probing software including an executable program that causes the client computer to download a predetermined Web page and configuration commands to prioritize the running of the probing software on the client computer relative to other processes.

16. A system for probing a Web site, comprising:
a distributed network of client computers having client characteristics including a geography, an operating system type, and a connection type, said client computers each including probing software causing the client computers to download a web site after receiving a work packet identifying a web site and to record performance measurement data representative of web site performance; and
a central server for controlling the probing performed by the distributed client computers, said central server including
a data structure corresponding to each client characteristic, each of said data structures including a work set identifier corresponding to each of a plurality of work sets, a listing of each client characteristic, and a time entry representing the last time that each work set was probed by a client computer having each client characteristic,
a processor for selecting a work packet for each client computer, and
a communication module for communicating with said distributed network of client computers including to receive performance measurement data from said client computers and to send said work packets to said client computers.

17. The system of claim 16 wherein said processor selects a work packet in response to receiving a work request by a specified client computer and wherein the selection of a work packing includes identifying each of the plurality of work sets having the client characteristics of the specified client computer, determining the time entry in each data table field corresponding to each of the identified work sets and the characteristics of the specified client computer, determining the current time, subtracting each time entry from the current time, calculating the product of the differences, and selecting the work set having the largest product.

18. The system of claim 17 wherein said central server further includes a performance database for storing performance measurement data received from each client computer, a data analysis user interface for selecting analysis options, a data display engine for generating a data display, a data analysis engine communicating with the performance database and the data display engine, and a data analysis user interface communicating with said data analysis engine for receiving a data display and displaying said data display to a user.
